(19) United States
(12) Patent Application Publication
(10) Pub. No.: US 2004/0244490 A1
(43) Pub. Date: Dec. 9, 2004

(54) Method and apparaus for measuring acoustic properties of materials to determine other physical propertiesfield of the invention

(76) Inventor: Steven Turner, Guernsey, WY (US)

Correspondence Address: Brian P. Kinnear, Holland & Hart, Suite 3200, 555 17th Street, Denver, CO, 80202, US

(21) Appl. No.: 10/760,790

(22) Filed: Jan. 19, 2004

Related U.S. Application Data
(60) Provisional application No. 60/441,800, filed on Jan. 22, 2003.

(51) Int. Cl. G01N 29/00

(52) U.S. Cl. 73/587

(57) ABSTRACT

One embodiment of the present invention relates to an acoustic property analysis device that does not require the predetermination of the fast and slow axis of the material. The device generally includes at least two acoustic transducer elements that are positioned on a sample in a specific orientation relative to one another. The acoustic transducer elements are independently coupled to waveform generators. The independent waveform generators can generate particular waves in each of the acoustic transducer elements to produce a resulting wave having a known polarization. The resulting wave propagates through the sample and is affected by the particular anisotropic properties of the sample. The components of the resulting wave are generally affected differently by the anisotropic properties in the sample. For example, one of the component waves may propagate faster than another wave through a particular defect in the sample. The combination of the component waves or the resulting wave will therefore change based on how each of the component waves are affected. The resulting wave bounces off the bottom of the sample and is then received by the acoustic transducer elements. Various parameters can then be measured to determine the characteristics of the sample.

### RELATED APPLICATION

This application claims priority to U.S. provisional patent application No. 60/441,800, filed Jan. 22, 2003, entitled: Methods and Apparatuses for Acoustic Property Determination of Materials.

The present invention relates to acoustic devices and, more particularly, to methods and apparatuses for using acoustic transducers, such as electromagnetic acoustic transducers, piezoelectric acoustic transducers, or the like, to measure properties of materials, such as solids or viscous fluids.

### BACKGROUND OF THE INVENTION

Non-destructive methodologies to determine properties of materials, such as, for example, steel rails, I-beams, and the like, have been around for years. One common non-destructive methodology uses acoustic transducers.

Generally, acoustic testing of materials, such as solids, uses a transducer to generate a shear wave and/or a longitudinal wave in the solid. The waves can be used to determine various properties of the material through which it travels. For more details regarding the generation of information based on shear waves, see U.S. Pat. No. 6,311,558 titled “ULTRASONIC STRAIN GAGE USING A MOTORIZED ELECTROMAGNETIC ACOUSTIC TRANSDUCER,” issued Nov. 6, 2001, and incorporated herein by reference (“the '558 patent”). Acoustic waves also travel using longitudinal waves, which also supply information regarding material properties. Unlike longitudinal waves that can propagate in gasses, liquids and solids, shear waves only propagate in solids or viscous materials.

Shear waves can be polarized when being introduced to a material. When the polarized shear waves, such as shear waves with a polarization angle of 45°, 37°, 12°, or 168°, or the like, are introduced into a material, the velocity of the wave through the material can be determined. Transducers, such as electromagnetic acoustic transducers, can produce shear waves with a propagation direction that is normal to the material surface as well as other angles of propagation. It is well known in the art that any transducer that can produce acoustic waves normal to the surface can be modified using, for example, a wedge or phased array of transducer elements to manipulate the propagation angle of the acoustic wave.

For materials that are not acoustically isotropic, the polarization of the shear wave, such as, for example a 27° wave polarization, having the slowest velocity through the material is known as the “pure mode” slow angle. The polarization of the shear wave having the fastest velocity through the material is known as the “pure mode” fast angle. Shear waves with an initial polarization equal to either of the pure mode angles maintain the same polarization as the shear wave propagates through the material. Shear waves with an initial polarization other than a pure mode polarization behave as if the wave was resolved into two component waves at the fast and slow pure mode angles. Since these components travel at different velocities, the arriving shear wave has a modified polarization that is generally elliptical. The polarization angle of the fast and slow pure modes are orthogonal to one another. In this example, with the slow angle 27°, the fast angle could be 17°.

Conventionally, the fast and slow polarization angles are determined by rotating a shear wave transducer to find the two polarization angles that give a peak response through the material (the '558 patent). The transducer is then set to generate an acoustic pulse (a.k.a. tone burst) in the material at either the fast or slow polarization angle with a subsequent identical acoustic pulse generated in the other polarization angle. Using the difference in, for example, the velocity or phase, and attenuation of the fast and slow shear waves, many properties of the material can be determined, as is commonly known in the art. However, the process of mechanically rotating the transducer to find the pure mode polarization angles, and then rotating to test the fast and slow polarization angles requires considerable time and can induce mechanical errors that require extensive compensation.

Thus, it would be desirous to develop methods and apparatuses capable of determining properties of materials without initial determination of the pure mode shear wave polarization angles, and to avoid the need for mechanical rotation of the transducer.

### SUMMARY OF THE INVENTION

The foregoing and other features, utilities and advantages of the invention will be apparent from the following more particular description of a preferred embodiment of the invention as illustrated in the accompanying drawings.

One embodiment of the present invention relates to an acoustic property analysis device that does not require the predetermination of the fast and slow axis of the material. Furthermore, the device does not require any mechanical rotation or manipulation of the transducer. The device generally includes at least two acoustic transducer elements that are positioned on a sample in a specific orientation relative to one another. The acoustic transducer elements are independently coupled to waveform generators. The independent waveform generators share a common time-base clock and can generate particular synchronized waves in each of the acoustic transducer elements to produce an initial resulting shear wave having a known initial polarization. The resulting shear wave propagates through the sample and is affected by the particular anisotropic properties of the sample. In particular, the resulting shear wave generally has components at the fast and slow polarization angles that travel at different velocities according to the anisotropic properties in the sample. For example, one of the component waves may propagate faster than the other wave through the sample because of internal stress or microstructure, or be affected differently according to the alignment of any defects. The combination of the component waves in the final resulting wave will therefore change based on how each of the component waves are affected. The final resulting wave may be received by a second transducer at the bottom of the sample. Alternatively, the component waves bounce off the bottom of the sample and the final resulting wave is then received by the original acoustic transducer or a separate receive transducer located at the top of the sample. Various parameters can then be measured to determine the characteristics of the sample.

A second embodiment of the present invention relates to overlapping or interleaving multiple coils of an ElectroMagnetic Acoustic Transducer (EMAT) to provide an intrinsic balance in the coupling efficiency of the two coils. The EMAT transducer coils are overlapped in a manner such that the average distance between each of the coils and the surface of the sample is essentially equal.

The acoustic property analysis device of the present invention has many advantages over the prior art. The prior art techniques for acoustically analyzing characteristics of a sample generally require the predetermination of the sample's fast and slow axis. The present invention overcomes this limitation by providing the ability to generate a wave through the sample with electronically steerable polarization. Therefore, a user of the present invention could steer the resulting acoustic wave's polarization to various angles and perform multiple iterations without having to know the fast and slow polarization axis of the sample in order to properly align the transducer. Another limitation of the prior art is that if an EMAT with multiple coils is constructed by “sandwiching” the coils on different layers between the magnet and the surface, each layer will have a different transduction efficiency because of the different distances from the coil to the surface. This may be overcome by weaving the windings of the coils through each other so that on average, each coil is the same distance from the surface, but this type of construction is expensive and difficult to automate. The present invention overcomes this limitation with a novel interleaving technique for overlapping EMAT coils while still permitting the preferred printed circuit board fabrication technique for each coil layer.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 is an illustrative block diagram of a control system consistent with one embodiment of the present invention;

FIG. 2 is a perspective view of an acoustic transducer arrangement illustrative of the present invention;

FIG. 3 is a perspective view of an electromagnetic acoustic transducer consistent with the present invention;

FIG. 4 is a perspective view of an alternative electromagnetic acoustic transducer consistent with the present invention; and

FIG. 5 is a perspective view of a piezoelectric acoustic transducer consistent with the present invention.

### DETAILED DESCRIPTION

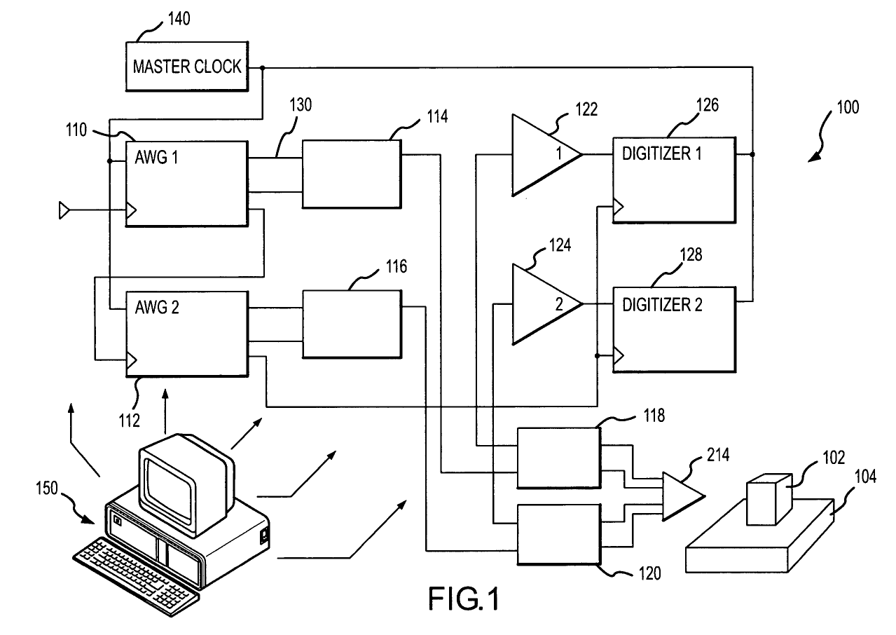

The present invention will be further explained with reference to the figures. In particular, FIG. 1 shows a functional block diagram of a control system 100 consistent with the present invention. While the control system is explained with particular reference to software components and hardware components, one of ordinary skill in the art will recognize control system 100 could be implemented using hardware, software, or a combination as shown. Control system 100 functions to provide power to acoustic transducer arrangement 102. Acoustic transducer arrangement 102 induces an acoustic tone in a sample material 104. Sample material 104 will be explained as a solid material, such as a steel rail or the like, but could be a viscous liquid. Control system 100 will be further explained below.

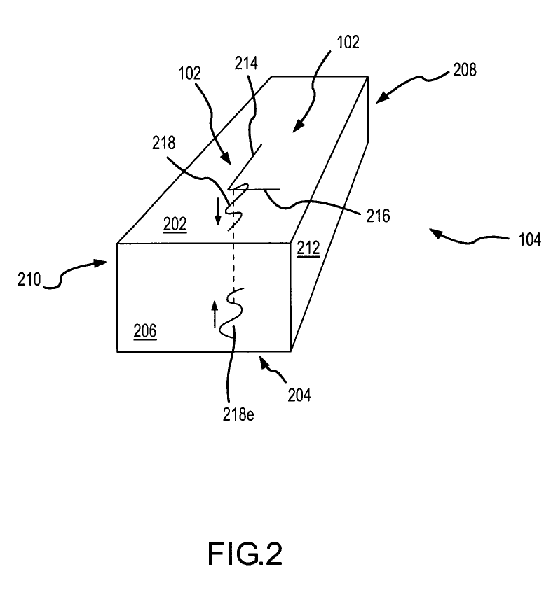

Acoustic transducer arrangement 102 and sample 104 will be explained with reference to FIG. 2. FIG. 2 shows sample materials 104, such as a cube of steel having a top side 202, a bottom side 204, a front side 206, a back side 208, a left side 210, and a right side 212. Arranged substantially adjacent top side 202 is acoustic transducer arrangement 102. Acoustic transducer arrangement 102 comprises at least two acoustic elements 214 and 216 that produce shear waves with polarization angles as indicated. In order to produce shear waves originating at substantially the same location on surface 202, the two acoustic elements are co-located by a method such as stacking the two elements or interleaving the two elements above the surface. Acoustic elements 214 and 216 will be described using EMAT coils as the acoustic elements, but one of ordinary skill in the art would understand on reading the disclosure that other types of acoustic elements capable of producing shear waves are possible, such as, for example, piezoelectric transducers. EMAT transducers, while a less efficient transducer than, for example, a piezoelectric transducer, induce sound waves directly in a conductive sample material 104 resulting in generally better readings.

As shown in FIG. 2, EMAT coils 214 and 216 are arranged orthogonal to each other. When electric pulses are supplied to EMAT coils 214 and 216 simulatenously, they produce a combined polarized acoustic shear wave that has a determinable polarization angle relative to the ratio of the amplitude of the pulses. If the pulses are in-phase, the resultant shear wave is linear. Likewise, if the pulses are out of phase, the resultant shear wave is elliptical. If the pulses are of equal amplitude and out of phase 90°, they produce a resultant circular shear wave. For ease of reference and explanation, the present invention will be explained using an initial linear shear wave, however, elliptical or circular waves could be used as well. Further, the below explanation is given assuming equal amplitude pulses on each coil, resulting in a 45° degree linear shear wave 218 traveling normal to top side 202. On reading the disclosure, one of skill in the art will now recognize that two orthogonal coils is a simple arrangement that will produce any polarization angle between 0° and 180°. More coils could be used, however. Further, coils arranged other than orthogonal could also be used to produce the same effect. Moreover, additional coils, such as a spiral coil, could be used to produce additional wave modes, such as a longitudinal wave. Thus, acoustic transducer arrangement 102 could have coils to produce a shear wave, a longitudinal wave, or the like.

Shear wave 218 travels through sample material 104 and bounces off bottom side 204 of sample material 104. If access is available to bottom side 204, a separate set of transducers (not shown) could be arranged substantially aligned with coils 214 and 216 to receive the pulse (a.k.a. through transmission). Alternatively, shear wave 218 bounces off bottom side 204 and is received by coils 214 and 216 (a.k.a. pulse-echo transmission). A second set of coils (not shown) could be arranged so coils 214 and 216 only transmit and the second set of coils receive. Control system 100 will be explained below using a pulse-echo transmission with one set of coils, but any of the transmission styles or coil arrangements could be used.

While traveling through sample material 104, shear wave 218 begins to change from a linearly polarized wave to an elliptically polarized wave depending on the degree of acoustic anisotropy encountered in the sample material 104 in the direction of the test. The change in polarization is due to the fact that one part of shear wave 218 propogates at a higher relative velocity than another part of shear wave 218 due to the acoustic anisotropy in the sample material 104. Thus, when shear wave 218 bounces off bottom side 204 and forms shear wave echo 218e, the two-dimensional polarization of shear wave echo 218e can then be accurately measured by analyzing the parameters of the resulting elliptically polarized wave. The parameters of the elliptically polarized wave include, for example, the phase shift between the component pulses (which started as in-phase for an initial linear shear wave) and the relative attenuation between the component pulses (which started as equal amplitudes for an initial 45° linear shear wave). Using these two parameters, for a sample set of pulses of different initial polarization and frequency (a.k.a. a sweep or tone burst), bulk properties of the sample material can be determined. One advantage of the present method is that the pure modes (fast and slow polarization angles) of sample material 104 do not need to be known. Although the fast and slow polarization angles do not need to be known, they can be simultaneously determined by analyzing the relative amplitude and velocity characteristics of the shear wave echo 218e for a small set of initial polarization values and frequencies.

It is believed that sufficient information regarding the sample material can be determined using as few as two or three sample pulses, however, more pulses are desirable to precisely measure the parameters. Further, because of quick processing time, the system is largely limited by the speed of sound through the material. Lastly, while the above was explained using a simplified single pulse echo description, in reality, the first or original pulse from acoustic transducer arrangement 102 generates an original pulse, a return echo, a subsequent pulse, and a return echo pulse. In other words, one pulse echo pair generates subsequent pulse echo pairs (with a reduced relative amplitude). The subsequent pulse echo pairs can be used by the present invention as additional pulse echoes. Thus, it is believed that a single original pulse echo with at least two subsequent pulse echo pairs may provide sufficient information regarding sample material 104.

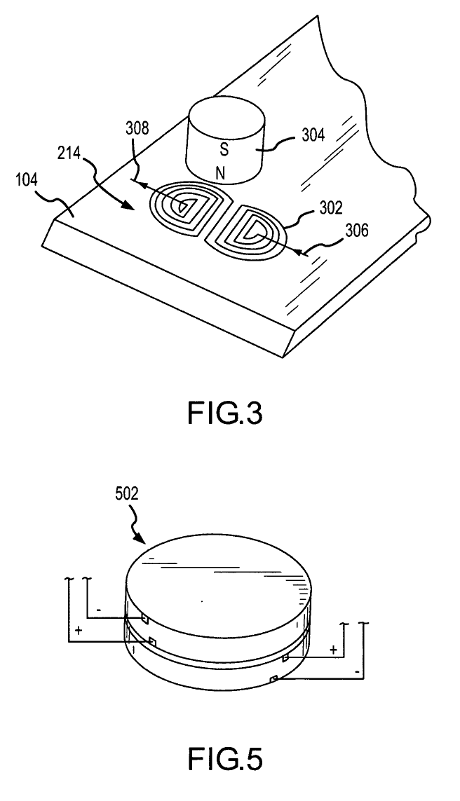

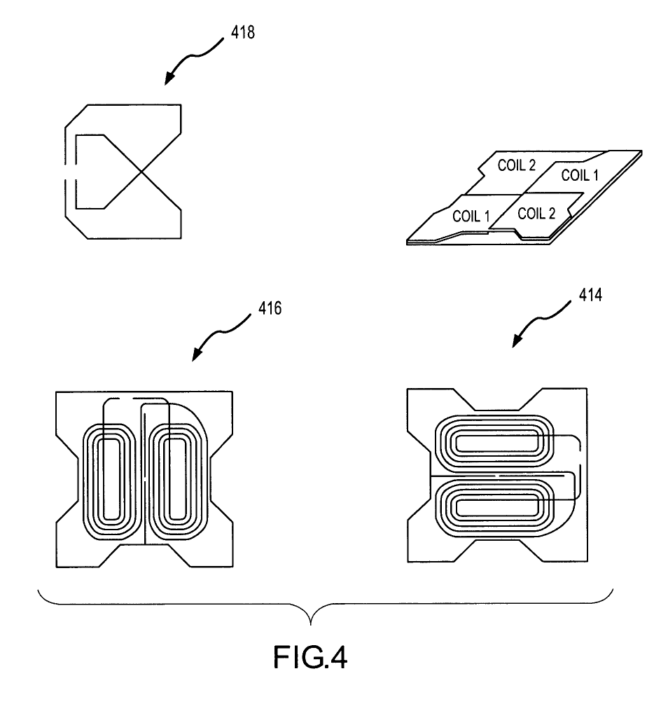

Reference is next made to FIG. 3, which illustrates a detailed drawing of one embodiment of coil 214 from FIG. 2. Coil 216 from FIG. 2 may or may not be the same as coil 214. One of skill in the art, on reading the disclosure, would recognize that types of windings for coils as well as types of acoustic transducers could be combined in various combinations. In other words, EMATs and piezoelectric transducers could be mixed and matched and remain consistent with this invention. As shown in FIG. 3, coil 214 is an EMAT comprising at least one conductor 302 arranged in a racetrack or figure eight pattern. A magnet 304 resides above conductor 302 such that conductor 302 is between magnet 304 and sample material 104. Power would be supplied to conductor 302 across points 306 and 308. As shown in FIG. 5, coil 214 could be, for example, a stacked piezoelectric transducer arrangement 502.

One of skill in the art will recognize that simply stacking EMAT coils 214 and 216 results in different power requirements for coils 214 and 216 to induce the same shear wave amplitude because of the difference in distance between each coil and the surface. While the different requirements can be compensated for by adjusting signal amplitudes, FIG. 4 shows an alternative acoustic transducer arrangement 400 that could be used to substitute for coils 214 and 216 in FIG. 2. The transducer arrangement 400 comprises coil 414 and coil 416. Coils 414 and 416 are interwoven in a manner analogous to closing the top of a four-sided cardboard box. Interweaving coils 414 and 416 makes the power requirements for coils 414 and 416 more similar to coils 214 and 216 illustrated in FIG. 2 because the distance of the coils to the surface of sample material 104 is, on average, equal. A third coil, such as a spiral shaped winding, could be added to the arrangement to produce, for example, longitudinal waves. In addition, other coils such as 418, may be added to act exclusively to receive waves while the initial two coils act exclusively to transmit waves. Coil 418 may also be used to monitor the transmit coils during transmit pulse generation to verify the initial polarization characteristics. The particular arrangement shown with the receive windings (each a single turn, in this example) at 45° to the transmit windings provides a simple means of confirming the proper balance of transmit signals to produce a 45° linear polarized shear wave. When the signals to the two transmit coils are correctly adjusted, the resultant signal can be measured on one coil and the other coil should indicate a null signal. Once the arbitrary waveform generators and gated linear amplifiers are calibrated to produce the correct 45° linear polarized shear wave, the same calibration values can be applied to produce other angles.

As explained above, using at least two transducer coils that substantially simultaneously provide an acoustic pulse produces shear wave 218 that can be polarized in a desired direction. Further, the initial shear wave can be linearly or elliptically polarized. Control system 100 has been designed to produce shear wave 218 having a predetermined polarization. As shown, control system 100 has two arbitrary waveform generators 110 and 112, two linear amplifiers 114 and 116, two diplexer and matching networks 118 and 120, two variable gain amplifiers 122 and 124, and two digitizers 126 and 128. Alternatively, other control system designs may be used and remain consistent with the present invention.

Arbitrary waveform generator 110, linear amplifier 114, and diplexer with matching network 118, supply power to coil 214. Arbitrary waveform generator 112, linear amplifier 116, and diplexer with matching network 120, supply power to coil 216. Because each path is substantially identical, only one will be explained. If however, more coils were used, more paths could be provided.

First, arbitrary waveform generator 110 generates a waveform 130. Waveform 130 may be programmed to produce any type of tone burst at coil 214 having particular parameters, such as, frequency, phase, amplitude, and duration. Further, the waveform could be modulated using frequency modulation, amplitude modulation, phase modulation, code modulation, or the like. The wave produced at coil 214 can be precisely controlled because the waveform generators 110 and 112 are operated from a common clock and therefore, the signals are precisely correlated to one another. Linear amplifier 114 amplifies waveform 130 to a power level capable of driving coil 214. In the case of an EMAT coil, waveform 130 needs to supply about 5 kW to coil 214. A piezoelectric transducer would require less power. Diplexer and matching network 118 couples the amplified waveform 130 to coil 214. The diplexer portion of network 118 switches between the transmitting and receiving portions of the circuit. The matching portion of network 118 is used to match the transmit and receive portions of the circuits.

When coil 214, shown in FIG. 2, receives a return echo, diplexer and matching network 118 are connected to the receive portion of the circuit. The received signal is sent to variable gain amplifier 122 and to digitizer 126, which can be any conventional sampler or A/D converter. The time delay between transmitting the wave and receiving the wave as well as the time delay between the two received waves (e.g., for coils 214 and 216) can be coherently measured because a master clock 140 provides timing for all the components associated with control system 100.

Waveform generators 110 and 112 receive input parameters from processor 150. Processor 150, which is shown as a personal computer, but could be any type of processor, provides parameters to waveform generators 110 and 112 so that the waveforms used to drive coils 214 and 216 can be manipulated easily. For example, having processor 150 supply identical parameters to generators 110 and 112 would produce a 45° linear polarized shear wave. By supplying different phase parameters, processor 150 could cause an elliptical wave to be generated. In addition, inverting waveform 130 could produce a 135° linear polarized shear wave.

Digitizers 126 and 128 sample the analog return echo and provide data that is then processed to determine parameters including but not limited to, polarization, velocity, phase, and amplitude, by processor 150. Processor 150, knowing the original pulse, and the information from a series of echo pulses associated with a tone burst, can solve a set of commonly known equations to generate information regarding the properties of the material.

Referring back to FIG. 2, sample material 104 is shown with orthogonal coils 214 and 216 to produce polarized shear wave 218 that is steerable in a polarization direction. Using one or two dimensional arrays of acoustic transducer arrangements, shear wave 218 could be manipulated to form various propagation angles, which would be useful for analyzing plates and the like.

While the invention has been particularly shown and described with reference to an embodiment thereof, it will be understood by those skilled in the art that various other changes in the form and details may be made without departing from the spirit and scope of the invention.

We claim:

1. An acoustic property analysis device comprising:
a sample;
at least two acoustic transducer elements disposed on the sample;
at least two waveform generators electrically coupled to the at least two acoustic transducer elements to independently generate waves in each of the at least two acoustic transducer elements; and
wherein, the independently generated waves produce a resulting wave with a predetermined polarization based on the combination of the independently generated waves in each of the at least two acoustic transducer elements.

2. The acoustic property analysis device of claim 1, wherein the property analysis device further includes a common clock coupled to each of the at least two waveform generators and each of the at least two receive signal digitizers that allows for precise signal correlation of transmitting and receiving waves.

3. The acoustic property analysis device of claim 1, wherein the sample is a solid.

4. The acoustic property analysis device of claim 1, wherein the sample is a viscous liquid.

5. The acoustic property analysis device of claim 1, wherein the at least two acoustic transducer elements are piezoelectric transducer elements.

6. The acoustic property analysis device of claim 1, wherein the at least two acoustic transducer elements are independent coils of an electromagnetic acoustic transducer (EMAT).

7. The acoustic property analysis device of claim 1, wherein the at least two acoustic transducer elements are interwoven electromagnetic acoustic transducer coils that have substantially the same transduction efficiency.

8. The acoustic property analysis device of claim 1, wherein the at least two acoustic transducer elements are disposed orthogonal to one another on the sample.

9. The acoustic property analysis device of claim 1, wherein the at least two waveform generators each further include:
an arbitrary waveform generator;
a gated linear amplifier; and
a diplexer and matching network.

10. The acoustic property analysis device of claim 1, wherein the predetermined polarization includes linear, elliptical and circular polarization.

11. An acoustic property analysis device comprising:
a sample;
at least two electromagnetic acoustic transducer elements disposed on the sample in an interwoven manner so as to provide substantially equal transduction efficiency; at least two waveform generators electrically coupled to the at least two acoustic transducer elements to independently generate waves in each of the at least two acoustic transducer elements; and
wherein, the independently generated waves produce a resulting wave with a predetermined polarization based on the combination of the independently generated waves in each of the at least two acoustic transducer elements.

12. A method of acoustically analyzing a sample material without initially knowing the fast and slow polarization axis of the material, comprising:
positioning at least two acoustic transducer elements on the sample in a predetermined orientation relative to one another;
coupling at least two waveform generators to the at least two acoustic transducer elements;
independently generating predetermined waves in each of the acoustic transducer elements to produce a resulting wave with a specific polarization; and
receiving the resulting wave, after the resulting wave propagates through the sample, and analyzing various characteristics about the resulting wave to determine various characteristics about the sample.

13. The method of claim 12, wherein the predetermined orientation is orthogonal.

14. The method of claim 12, wherein the at least two acoustic transducer elements are piezoelectric transducers.

15. The method of claim 12, wherein the wherein the at least two acoustic transducer elements are independent coils of an electromagnetic acoustic transducer (EMAT).

16. The method of claim 12, wherein the at least two acoustic transducer elements are interwoven electromagnetic transducer coils that have substantially the same transduction efficiency.

17. The method of claim 12, wherein the at least two waveform generators are electrically coupled to the at least two acoustic transducer elements to independently generate acoustic waves.

18. The method of claim 12, wherein generating in phase waves between the at least two acoustic transducer elements will produce a resulting shear wave with a linear polarization.

19. The method of claim 12, wherein generating out of phase waves between the at least two acoustic transducer elements will produce a resulting shear wave with a non-linear polarization, such as elliptical or circular polarization.

20. The method of claim 12, wherein generating frequency, amplitude or code modulated waves between the at least two acoustic transducer elements will produce a resulting shear wave with varying polarization characteristics over the duration of the generated pulse.

21. The method of claim 12, wherein generating a programmed sequence of test waves between the at least two acoustic transducer elements will produce a corresponding sequence of shear waves with selectable linear, elliptical or circular polarization with arbitrary polarization angles and arbitrary frequencies.

22. The method of claim 12, wherein the various characteristics of the resulting wave include the phase shift between component waves, the attenuation between the component waves, the individual velocities of the component waves, the velocity of the resulting wave, the resulting polarization, and the resulting amplitude.

23. The method of claim 12, wherein the various characteristics of the sample include the fast and slow polarization angles, and the alignment and nature of various anisotropic characteristics of the material known to be related to acoustic measurements that include stress, microstructure, surface defects and internal defects.
